(19) United States
(12) Patent Application Publication
(10) Pub. No.: US 2025/0283543 A1
(43) Pub. Date: Sep. 11, 2025

(54) ROTARY VALVE

(71) Applicant: TI AUTOMOTIVE TECHNOLOGY CENTER GMBH, Rastatt (DE)

(72) Inventors: Johannes GOELLER, Crispenhofen (DE); Albert BOECKER, Ettlingen (DE); Matthias WINTER, Karlsruhe (DE); Artem TUZIN, Stutensee (DE)

(21) Appl. No.: 19/104,999

(22) PCT Filed: Aug. 9, 2023
(86) PCT No.: PCT/EP2023/072054

§ 371 Date: Feb. 19, 2025

(30) Foreign Application Priority Data
Aug. 19, 2022 (EP) 22191248.8

(51) Int. Cl. F16K 11/16; B60K 11/02

(52) U.S. Cl. CPC F16K 11/165; B60K 11/02

(57) ABSTRACT

A rotary valve includes a valve housing with a valve chamber, wherein the valve chamber has a chamber wall into which at least two fluid openings are introduced. The valve chamber accommodates a valve core, wherein the valve core is provided with a channel structure which interacts with the fluid openings, wherein the valve core is rotatorily accommodated in the valve chamber and can be set in rotation via a drive shaft. The valve core is formed in multiple parts and has at least a first valve core element and a second valve core element, wherein the first valve core element has a first channel structure and the second valve core element has a second channel structure. The first valve core element and the second valve core element are operatively connected to the drive shaft.

### RELATED APPLICATIONS

The present disclosure claims priority to and is a national phase application of PCT Application PCT/IB2023/072054, filed Aug. 9, 2023, which claims priority to Euorpean application Ser. No. 22/191,248.8, filed Aug. 19, 2022, the entire contents of which are incorporated herein by reference.

### FIELD

The disclosure relates to a rotary valve, comprising a valve housing with a valve chamber, wherein the valve chamber has a chamber wall into which at least two fluid openings are introduced, wherein the valve chamber accommodates a valve core, wherein the valve core is provided with a channel structure which interacts with the fluid openings, wherein the valve core is rotatorily accommodated in the valve chamber.

### BACKGROUND

Such a rotary valve is known, for example, from DE 10 2018 009 680 A1. Rotary valves of the mentioned type are often used in cooling circuits to control the flow of coolant. A cooling fluid can flow in and out through the fluid openings provided in the valve housing. The channel structure arranged in the valve core controls the coolant flow, wherein, depending on the embodiment and number of fluid openings, different cooling circuits can be activated, the volume flow can be regulated or the flow direction adjusted.

The embodiment as a rotary valve is advantageous because the coolant flow is adjusted by rotating the valve core, wherein the corresponding actuator for rotating the valve core is formed in a simple manner and can be easily controlled. Accordingly, rotary valves and the associated actuators can be manufactured in a cost-effective manner. In addition, rotary valves only require a small installation space.

Such rotary valves are particularly advantageous with regard to the use in temperature control circuits in the field of electromobility. To achieve a high range for electric vehicles, for example, it is necessary to control the temperature of electrical components. The components of electric vehicles whose temperature needs to be controlled are, in particular, electrical energy storage units, but also the power electronics or connectors of fast-charging devices. An electrical energy storage device has a best possible capacity only in a very small temperature spectrum. Therefore, it is necessary to heat electrical energy storage devices of electric vehicles at low ambient temperatures and to cool them at high outside temperatures or during high load changes.

For this purpose, it is known to provide a temperature control circuit through which a temperature control medium flows. Depending on the requirements, the temperature control medium can either be heated in a heating device or cooled in a cooling device. The control of the temperature control medium flow is at least partially performed via a rotary valve. This can result in the need for complex channel structures in the valve core.

### SUMMARY

The present disclosure provides a rotary valve which can be manufactured at low cost, and which allows for a complex control of temperature control circuits.

The rotary valve according to the disclosure comprises a valve housing with a valve chamber, wherein the valve chamber has a chamber wall into which at least two fluid openings are introduced, wherein the valve chamber accommodates a valve core, wherein the valve core is provided with a channel structure which interacts with the fluid openings, wherein the valve core is rotatorily accommodated in the valve chamber and can be set in rotation via a drive shaft, wherein the valve core is formed in multiple parts and has at least a first valve core element and a second valve core element, wherein the first valve core element has a first channel structure and the second valve core element has a second channel structure, wherein the first valve core element and the second valve core element are operatively connected to the drive shaft.

Due to the embodiment of the valve core in multiple parts it is possible to realize complex controls for temperature control circuits. The first valve core element and the second valve core element are provided with channel structures that can interact with the respective fluid openings independently of each other. Accordingly, a first temperature control circuit can be realized via the channel structure of the first valve core element and a second temperature control circuit via the channel structure of the second valve core element. The first valve core element and the second valve core element are operatively connected to the drive shaft, wherein the two valve core elements can be rotatable independently of each other. This means that either only the first valve core element or only the second valve core element or both valve core elements can be rotated by the rotational movement of the drive shaft. This allows implementing complex controls for different temperature control circuits at low cost using simple means.

The first valve core element can be operatively connected to the drive shaft via a first clutch. The clutch transmits the torque of the drive shaft to the first valve core element. The clutch can be formed in such a way that the flow of force is selectively interrupted, so that no torque transmission and correspondingly no rotation of the valve core element takes place when the drive shaft rotates.

The second valve core element can be operatively connected to the drive shaft via a second clutch. Depending on the requirements for controlling the temperature control circuit, it is conceivable that only the first valve core element is provided with a clutch or only the second valve core element is provided with a clutch or that both valve core elements are each provided with a clutch. In particular, the embodiment with two clutches enables particularly flexible and complex control of different temperature control circuits. The embodiment with only one clutch respectively is cost-effective.

The first clutch and/or the second clutch can be formed as a freewheel clutch. A clutch formed as a freewheel transmits torque only in one direction of rotation whereas no torque is transmitted in the opposite direction of rotation. A freewheel is a passive clutch and allows switching operations without the use of auxiliary energy. Alternatively, it is conceivable that the clutches are formed as switching clutches and are switched via an actuator, for example.

The freewheel of the first clutch can transmit a torque in a first direction of rotation. The freewheel of the second clutch can transmit a torque in a second direction of rotation which is opposite to the first direction of rotation. In this embodiment, rotation of the drive shaft in a first direction causes only one valve core element to rotate and rotation in the opposite direction causes the other valve core element to rotate. As a result, one valve core element remains in one position when the drive shaft rotates while the other valve core element changes its position. This allows complex switching operations to be realized with simple means.

Latching elements can be provided. These can be formed in such a way that they cause an increased torque for the rotary movement of the valve core elements at predetermined rotary positions. This can counteract unwanted rotational movements of the valve core elements, for example due to fluid forces, vibrations or other influences such as drag torques. The friction of the valve core on the chamber wall can be used to prevent unwanted rotary movements.

The rotary valve can be equipped with one or more sensors to determine the position of the valve core elements. The sensors allow the detection of the angular position of the valve core elements, which can be realized by measuring pressure, fluid flow or position, for example. If the sensors detect a loss of position, the valve core elements can be brought back into the correct position via a control system.

The freewheel clutch can be formed in such a way that it only engages at a predetermined number of positions. This embodiment allows freewheeling over a short distance, even in the direction of rotation in which the torque is transmitted. This allows position monitoring without additional sensors.

The first valve core element and the second valve core element can be operatively connected to each other via a latching means. In doing so, the latching means can be formed in such a way that the two valve core elements can rotate independently of each other in one direction of rotation and latch together in a second direction of rotation, so that the two valve core elements are rotated equally in the second direction of rotation. In this embodiment, one valve core element can be rotated in both directions while the other valve core element can only rotate in one direction of rotation.

The first valve core element and the second valve core element can be arranged one above the other when viewed in the longitudinal direction, i.e., in the direction of the axis of rotation. In this embodiment, the valve core elements are arranged in a stack in the valve housing and the channel structures of the two valve core elements are each connected to fluid openings preferably independently of each other. This embodiment is particularly suitable for controlling several independent temperature control circuits. In doing so, the first valve core element can influence a first temperature control circuit, and the second valve core element can influence a second temperature control circuit.

According to an alternative embodiment, the first valve core element and the second valve core element are nested radially within one another. In this embodiment, one valve core element has a concentric recess in which the other valve core element is arranged. In this embodiment, the channel structures of the two valve core elements can be connected to each other and particularly complex channel structures can be realized.

According to a further alternative embodiment, multiple valve core elements are provided, some valve core elements are arranged one above the other when viewed in the longitudinal direction and further valve core elements are nested inside one another.

The valve housing can be formed in multiple parts. In this embodiment, it is particularly conceivable that the first valve core element is allocated to a first valve housing part and the second valve core element is allocated to a second valve housing part. With this embodiment, it is particularly easy to separate different material flows from one another, so that a first material flow flows through the first valve core element and a second material flow flows through the second valve core element. By means of the multi-part embodiment of the valve housing, internal leaks can be prevented.

### BRIEF DESCRIPTION OF THE DRAWINGS

Some embodiments of the rotary valve according to the disclosure are explained in more detail below with reference to the figures. These show, each schematically:

FIG. 1 in section, a rotary valve with two valve core elements arranged one above the other in the longitudinal direction;

FIG. 2 the rotary valve according to FIG. 1 with latching means;

FIG. 3 a rotary valve with a multi-parts valve housing;

FIG. 4 a rotary valve with valve core elements nested within one another.

### DETAILED DESCRIPTION

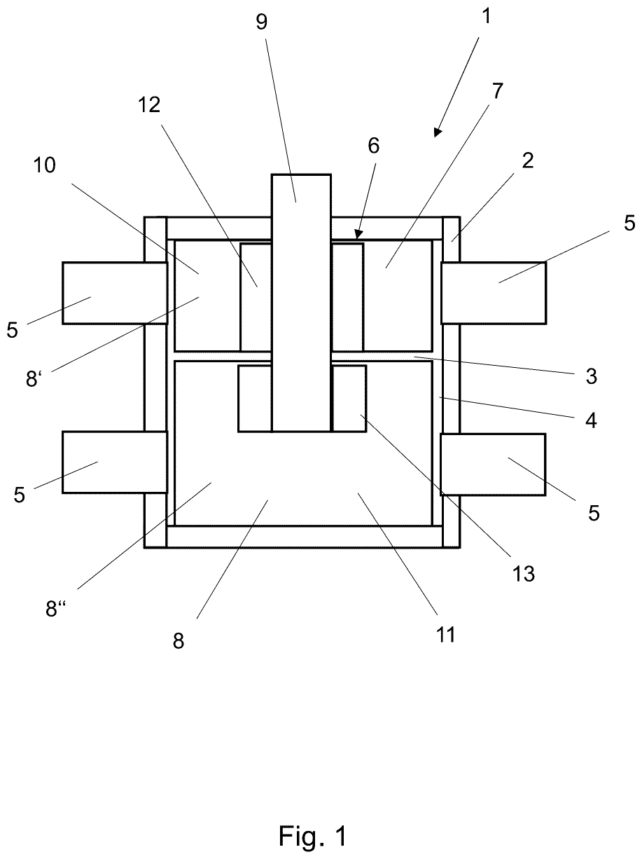

FIG. 1 shows a rotary valve 1 which forms part of a temperature control circuit of an indoor unit to be air-conditioned. In the present case, the rotary valve 1 is used in electromobility applications as part of the temperature control circuit of an electric vehicle. The rotary valve 1 is integrated into a temperature control circuit of an electric motor drive of an electric vehicle and directs volume flows of the medium conducted in the temperature control circuit to the electrical energy storage devices and electric motors as well as to the power electronics. The temperature control medium flows of the temperature control circuit can be controlled by the rotary valve 1.

In particular, it is conceivable to modify the volume flow of the temperature control medium, for example, to increase or decrease it. Furthermore, by rotating the valve core 7, different fluid openings 5 can be connected in a flow-conducting manner and thus the flow direction of the temperature control medium can be changed, or other components of the temperature control circuit can be controlled. In this respect, the rotary valve 1 according to the disclosure forms also a directional control valve through which various components of the equipment to be temperature-controlled can be individually and specifically supplied with temperature control medium and, if necessary, also separated from the temperature control medium flow.

Depending on the ambient temperature and power requirement, for example, a temperature control medium flow can initially be directed exclusively to the electrical energy storage devices and cool or heat the electrical energy storage devices there depending on the ambient temperatures. For high power requirements, a coolant flow can be directed to the power electronics and also to the electric motors to cool these components. The modification of the coolant flow takes place by means of the rotary valve 1. In this case, the rotary valve 1 can replace multiple solenoid valves, so that the temperature control circuit can be produced in a cost-effective manner.

FIG. 1 shows a rotary valve 1 with a valve housing 2 formed of plastic, in which a valve chamber 3 is arranged. The valve chamber 3 has a chamber wall 4 into which multiple fluid openings 5 are introduced. The valve chamber 3 has a receiving opening 6 on the end face and the valve chamber 3 accommodates a valve core 7. The valve core 7 is provided with a channel structure 8 which interacts with the fluid openings 5. The valve core 7 is rotatorily accommodated in the valve chamber 3 and provided with a drive shaft 13, via which the valve core 7 can be set in rotation by an actuator. The valve housing 2 and the valve core 7 are formed of plastic and manufactured by injection molding.

The valve core 7 is formed in multiple parts and has a first valve core element 10 and a second valve core element 11. A first channel structure 8′ is introduced into the first valve core element 10 and a second channel structure 8″ is introduced into the second valve core element 11. The first valve core element 10 and the second valve core element 11 are operatively connected to the drive shaft 9. A first clutch 12 is arranged between the drive shaft 9 and the first valve core element 10 and a second clutch 13 is arranged between the drive shaft 9 and the second valve core element 11. The first clutch 12 and the second clutch 13 are formed as freewheel clutches and are arranged in such a way that the freewheel of the first clutch 12 transmits a torque in a first direction of rotation and the freewheel of the second clutch 13 transmits a torque in a second direction of rotation which is opposite to the first direction of rotation. Accordingly, rotation of the drive shaft 9 in the first direction of rotation causes the first valve core element 10 to rotate while the drive shaft 9 does not transmit any torque to the second valve core element 11. In the second direction of rotation, no torque is transmitted from the drive shaft 9 to the first valve core element 10 and the second valve core element 11 is set in rotation by torque transmission.

In the embodiment according to FIG. 1, the first valve core element 10 and the second valve core element 11 are arranged one above the other when viewed in the longitudinal direction of the drive shaft 9. The channel structures 8′, 8″ are each in operative connection with fluid openings 5.

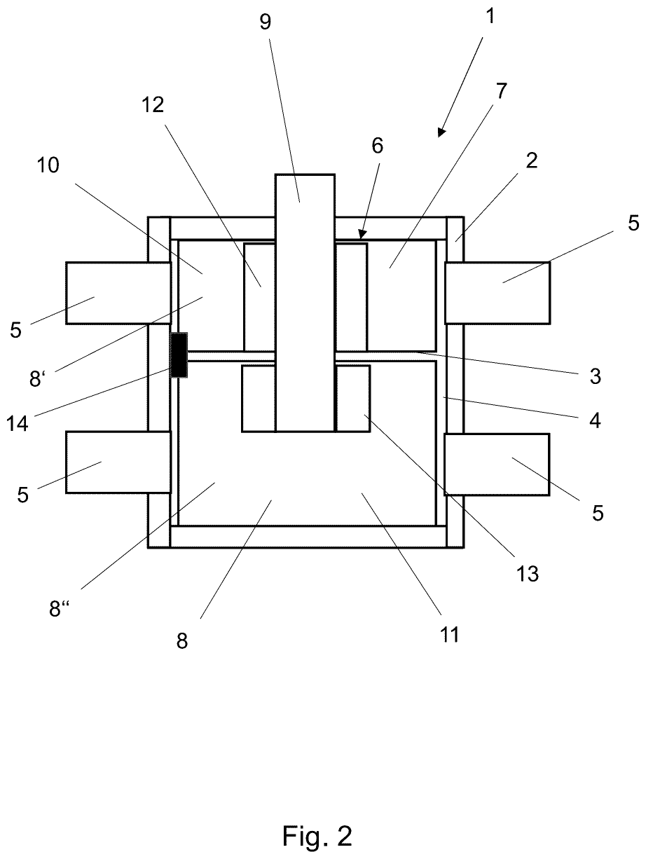

FIG. 2 shows a further development of the rotary valve 1 shown in FIG. 1.

In the present embodiment, the first valve core element 10 is operatively connected to the second valve core element 11 via a latching means 14. The latching means 14 is formed as a freewheel clutch and ensures that the first valve core element 10 can rotate independently of the second valve core element 11 in a first direction of rotation whereas both valve core elements 10, 11 rotate equally in a second direction of rotation due to torque transmission via the latching means 14. In this embodiment, the first valve core element 10 is connected to the drive shaft 9 via the first clutch 12 and the second valve core element 11 via the second clutch 13. Rotation of the drive shaft 9 in a first direction of rotation causes only one valve core element 10 to rotate whereas, in the second direction of rotation, both valve core elements 10, 11 rotate equally due to the locking of the latching means 14.

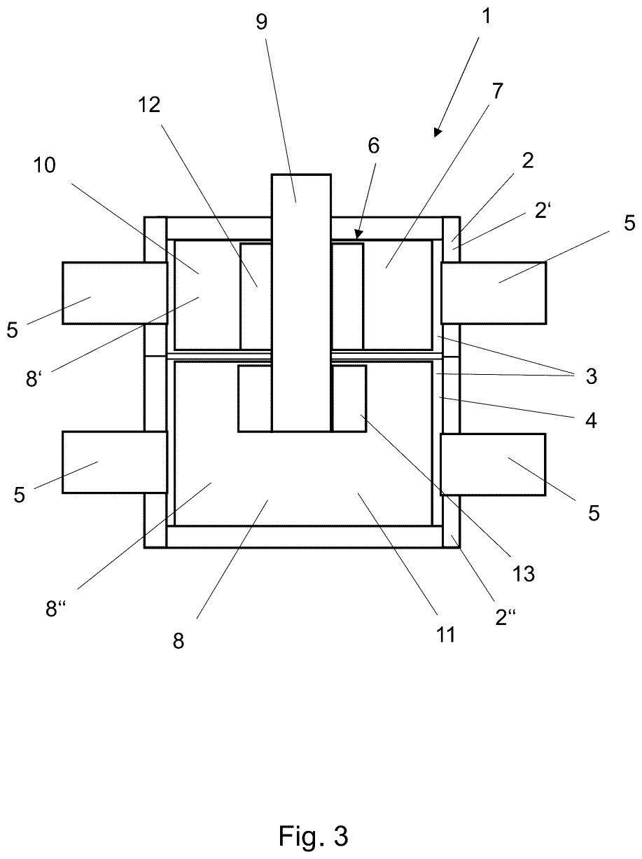

FIG. 3 shows a further development of the rotary valve 1 shown in FIG. 1. In this embodiment, the valve housing 2 is formed in multiple parts and has a first valve housing element 2′ and a second valve housing element 2″. The first valve core element 10 is arranged in the first valve housing element 2′ and the second valve core element 11 in the second valve housing element 2″.

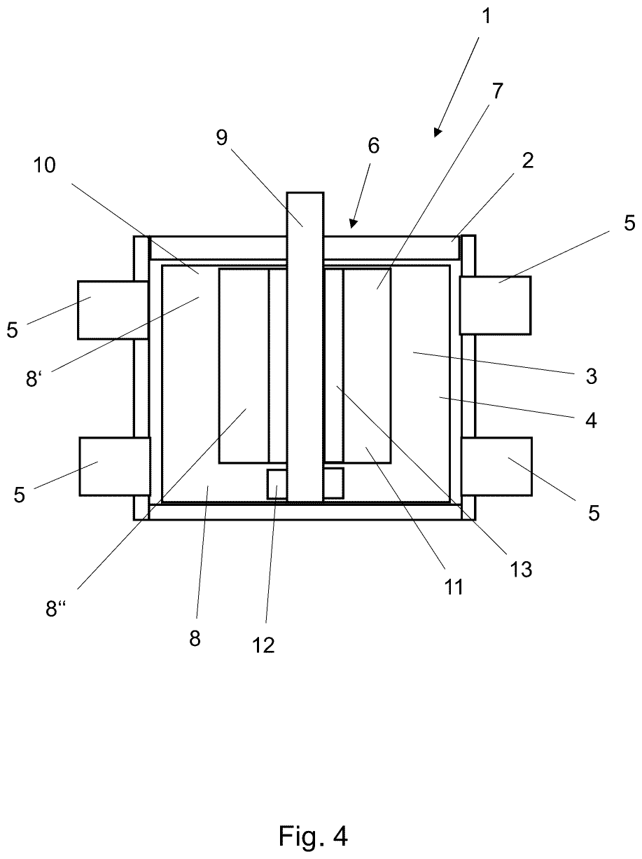

FIG. 4 shows a rotary valve 1 with a valve housing 2 formed of plastic, in which a valve chamber 3 is arranged. The valve chamber 3 has a chamber wall 4 into which multiple fluid openings 5 are introduced. The valve chamber 3 has a receiving opening 6 on the end face and the valve chamber 3 accommodates a valve core 7. The valve core 7 is provided with a channel structure 8 which interacts with the fluid openings 5. The valve core 7 is rotatorily accommodated in the valve chamber 3 and provided with a drive shaft 13, via which the valve core 7 can be set in rotation by an actuator.

The valve core 7 is formed in multiple parts and has a first valve core element 10 and a second valve core element 11. A first channel structure 8′ is introduced into the first valve core element 10 and a second channel structure 8″ is introduced into the second valve core element 11. The first valve core element 10 and the second valve core element 11 are operatively connected to the drive shaft 9. A first clutch 12 is arranged between the drive shaft 9 and the first valve core element 10 and a second clutch 13 is arranged between the drive shaft 9 and the second valve core element 11. The first clutch 12 and the second clutch 13 are formed as freewheel clutches and are arranged in such a way that the freewheel of the first clutch 12 locks in a first direction of rotation and the freewheel of the second clutch 13 locks in a second direction of rotation which is opposite to the first direction of rotation. Accordingly, rotation of the drive shaft in the first direction of rotation causes the first valve core element 10 to rotate while the drive shaft 9 does not transmit any torque to the second valve core element 11. In the second direction of rotation, no torque is transmitted from the drive shaft 9 to the first valve core element 10 and the second valve core element 11 is set in rotation by torque transmission.

In the embodiment shown in FIG. 4, the first valve core element 10 and the second valve core element 11 are nested within one another. For this purpose, a concentric recess is introduced in the first valve core element 10, in which the second valve core element 11 is arranged. The two channel structures 8′, 8″ are in operative connection with each other.

1. A rotary valve, comprising a valve housing with a valve chamber, wherein the valve chamber has a chamber wall into which at least two fluid openings are introduced, wherein the valve chamber accommodates a valve core, wherein the valve core is provided with a channel structure which interacts with the fluid openings, wherein the valve core is rotatorily accommodated in the valve chamber and can be set in rotation via a drive shaft, wherein the valve core is formed in multiple parts and has at least a first valve core element and a second valve core element, wherein the first valve core element has a first channel structure and the second valve core element has a second channel structure, wherein the first valve core element and the second valve core element are operatively connected to the drive shaft.

2. The rotary valve according to claim 1, wherein the first valve core element is operatively connected to the drive shaft via a first clutch.

3. The rotary valve according to claim 1, wherein the second valve core element is operatively connected to the drive shaft via a second clutch.

4. The rotary valve according to claim 2, wherein the first clutch and/or the second clutch are formed as a freewheel clutch.

5. The rotary valve according to claim 4, wherein the freewheel of the first clutch transmits a torque in a first direction of rotation and the freewheel of the second clutch in a second direction of rotation which is opposite to the first direction of rotation.

6. The rotary valve according to claim 1, wherein the first valve core element and the second valve core element are operatively connected to each other via a latching means.

7. The rotary valve according to claim 1, wherein the first valve core element and the second valve core element are arranged one above the other when viewed in the direction of the axis of rotation.

8. The rotary valve according to any of claim 1, wherein the first valve core element and/or the second valve core element are nested radially within one another.

9. The rotary valve according to any of claim 1, wherein the valve housing is formed in multiple parts.

10. The rotary valve according to claim 9, wherein a first valve housing element accommodates the first valve core element and a second valve housing element accommodates the second valve core element.

11. A temperature control circuit of a vehicle, comprising a rotary valve configured-according to claim 1.

12. The temperature control circuit according to claim 11, wherein the vehicle is an electronically powered vehicle.
